(19) United States
(12) Patent Application Publication
(10) Pub. No.: US 2009/0121611 A1
(43) Pub. Date: May 14, 2009

(54) PLASMA DISPLAY PANEL

(76) Inventor: Jung-Min Kim, Suwon-si (KR)

Correspondence Address: CHRISTIE, PARKER & HALE, LLP, PO BOX 7068, PASADENA, CA, 91109-7068, US

(21) Appl. No.: 12/269,210

(22) Filed: Nov. 12, 2008

(30) Foreign Application Priority Data
Nov. 14, 2007 (KR) 10-2007-0116149

(51) Int. Cl. H01J 63/04

(52) U.S. Cl. 313/485

(57) ABSTRACT

A plasma display panel (PDP) is provided. The PDP includes: a first substrate and a second substrate facing each other; a plurality of first barrier ribs on the second substrate defining a plurality of cells between the first substrate and the second substrate; pairs of scan electrodes and sustain electrodes on the first substrate; a plurality of second barrier ribs each dividing a corresponding cell of the cells into a primary discharge space and an auxiliary discharge space; a plurality of address electrodes on the second substrate. A portion of an address electrode among the address electrodes corresponding to the auxiliary discharge space is wider than other portions of the address electrode, thereby providing an improved addressing discharge.

### CROSS-REFERENCE TO RELATED PATENT APPLICATIONS

This application claims priority to and the benefit of Korean Patent Application No. 10-2007-0116149, filed on Nov. 14, 2007, in the Korean Intellectual Property Office, the disclosure of which is incorporated herein in its entirety by reference.

### BACKGROUND OF THE INVENTION

1. Field of the Invention

The present invention relates to a plasma display panel (PDP), and more particularly, to an addressing operation of a PDP.

2. Description of the Related Art

In a PDP, a plurality of discharge cells arranged in a matrix are interposed between a front substrate which has disposed thereon scan electrodes and sustain electrodes for generating discharges between them, and a rear substrate which has disposed thereon a plurality of address electrodes. The front substrate and the rear substrate are bonded and face each other, a discharge gas (e.g., a predetermined discharge gas) is injected between the front and rear substrates, and phosphors coated in the discharge cells are excited by generating a discharge pulse (e.g., a predetermined discharge pulse) between discharge electrodes (that is, the scan and sustain electrodes) so as to generate visible light, thereby realizing a desired image.

In order to realize gradation (e.g., color, brightness, or gray levels) of an image, PDPs having a structure as described above perform a time-division operation by dividing one frame of an image into several sub-fields having different light emissions, in which each of the sub-fields is divided into a reset period to uniformly generate a discharge, an address period to select discharge cells, and a sustain period to realize gradation of an image according to the number of discharges. In the address period, a kind of auxiliary discharges are generated between an address electrode and a scan electrode, and a wall voltage is formed in the selected discharge cells so as to form an environment suitable for sustain discharges.

In general, the address period requires a higher voltage to generate an address discharge than that required for a sustain discharge. Therefore, a low input voltage, that is a low address voltage, for performing a smooth addressing operation and providing a high voltage margin are essential to improve the operation efficiency and discharge stability of a PDP. In addition, for PDPs with full-HD resolution, the number of discharge cells required substantially increases, and thus the number of address electrodes allotted to the discharge cells also increases. Therefore, a circuit unit of a PDP should be able to cope with high power consumption. Therefore, a PDP should have a high operation efficiency in order to operate with lower electric power. In addition, a high xenon (Xe) display using a high partial pressure of Xe in the discharge gas injected inside the PDP can provide a high luminous efficiency but requires a relatively high address voltage for initiating a discharge. Thus, a PDP should provide a sufficient address voltage margin to realize a highly efficient display.

### SUMMARY OF THE INVENTION

Embodiments of the present invention provide a plasma display panel (PDP) having a high operating efficiency obtained by improving an address voltage margin.

Embodiments of the present invention also provide a PDP having a high quality and high contrast effect obtained by removing noise brightness, such as a discharge light generated when an address discharge occurs or a background light.

Embodiments of the present invention also provide a PDP suitable for displaying high resolution images with high efficiency.

According to one embodiment of the present invention, a plasma display panel (PDP) is provided. The PDP includes: a first substrate and a second substrate facing each other; a plurality of first barrier ribs defining a plurality of cells between the first substrate and the second substrate; pairs of scan electrodes and sustain electrodes extending on the first substrate and configured to generate display discharges in the plurality of cells; a plurality of second barrier ribs on the second substrate each dividing a corresponding one of the cells into a primary discharge space and an auxiliary discharge space adjacent to the primary discharge space, a second barrier rib among the second barrier ribs being closer to a corresponding scan electrode among the scan electrodes than a corresponding sustain electrode among the sustain electrodes; a plurality of address electrodes configured to perform address discharges together with the scan electrodes, the plurality of address electrodes extending on the second substrate in a direction perpendicular to a direction in which the scan electrodes extend, wherein a portion of an address electrode among the address electrodes is wider than another portion of the address electrode; and a phosphor layer in the primary discharge space.

The portion of the address electrode may corresponds to the auxiliary discharge space and may be wider than a portion of said another portion of the address electrode corresponding to the primary discharge space.

The portion that is wider than said another portion of each of the address electrodes may include one or more protrusions.

At least one portion of the one or more protrusions may be directly under at least one portion of the auxiliary discharge space, and the at least one portion of the one or more protrusions and the at least one portion of the auxiliary discharge space may overlap each other.

The second barrier ribs may face the scan electrodes, and a plurality of discharge gaps may be between the second barrier ribs and the scan electrodes.

The second barrier ribs may have a height less than that of the first barrier ribs.

The phosphor layer may not be formed in the auxiliary discharge space.

The PDP may further include a protective layer on the scan electrodes and the sustain electrodes.

The PDP may further include an electron emission material layer in the auxiliary discharge space.

The PDP may further include an electron emission material layer on top surfaces of the second barrier ribs adjacent to the scan electrodes.

According to another embodiment of the present invention, a PDP is provided. The PDP includes: a first substrate and a second substrate facing each other; a plurality of first barrier ribs on the second substrate defining a plurality of cells between the first substrate and the second substrate; pairs of scan electrodes and sustain electrodes extending on the first substrate and configured to generate discharges in the plurality of cells; a dielectric layer on the scan electrodes and the sustain electrodes and having grooves in positions at least corresponding to the scan electrodes; a plurality of second barrier ribs on the second substrate each dividing a corresponding cell of the cells into a primary discharge space and an auxiliary discharge space adjacent to the plurality of primary discharge space, a second barrier rib among the plurality of second barrier ribs being closer to a corresponding scan electrode among the scan electrodes than a corresponding sustain electrode among the sustain electrodes; a plurality of address electrodes configured to perform address discharges together with the scan electrodes, and the plurality of address electrodes extending on the second substrate in a direction perpendicular to a direction in which the scan electrodes extend, wherein a portion of an address electrode among the address electrodes is wider than another portion of the address electrode; and a phosphor layer in the primary discharge space.

The portion of the address electrode corresponds to the auxiliary discharge space and is wider than a portion of said another portion of the address electrode corresponding to the primary discharge space.

The portion that is wider than another portion of each of the address electrodes may include one or more protrusions.

At least one portion of the one or more protrusions may be directly under at least one portion of the auxiliary discharge space, and the at least one portion of the one or more protrusions and the at least one portion of the auxiliary discharge space may overlap each other.

The second barrier ribs may face the scan electrodes, and discharge gaps may be between the second barrier ribs and the scan electrodes.

The first and second barrier ribs may have the same height.

The phosphor layer may not be formed in the auxiliary discharge space.

The PDP may further include a protective layer on the scan electrodes and the sustain electrodes.

The PDP may further include an electron emission material layer in the auxiliary discharge space.

The PDP may further include an electron emission material layer on top surfaces of the second barrier ribs adjacent to the scan electrodes.

### BRIEF DESCRIPTION OF THE DRAWINGS

The above and other features and aspects of the present invention will become more apparent by describing in detail exemplary embodiments thereof with reference to the attached drawings in which:

FIG. 1 is a partial exploded perspective view of a PDP according to a first embodiment of the present invention;

FIG. 2 is a vertical cross-sectional view of the PDP of FIG. 1 taken along the line II-II;

FIG. 3 is a plan view of the PDP of FIG. 1;

FIG. 4 is a perspective view illustrating the arrangement of some of the components of the PDP illustrated in FIG. 1;

FIG. 5 is a vertical cross-sectional view of a PDP according to a second embodiment of the present invention;

FIG. 6 is a vertical cross-sectional view of a PDP according to a third embodiment of the present invention;

FIG. 7 is a partial exploded perspective view of a PDP according to a fourth embodiment of the present invention; and

FIG. 8 is a vertical cross-sectional view of the PDP of FIG. 7, taken along the line VIII-VIII.

### DETAILED DESCRIPTION OF EXEMPLARY EMBODIMENTS

The present invention will now be described more fully with reference to the accompanying drawings, in which exemplary embodiments of the invention are shown.

### First Embodiment

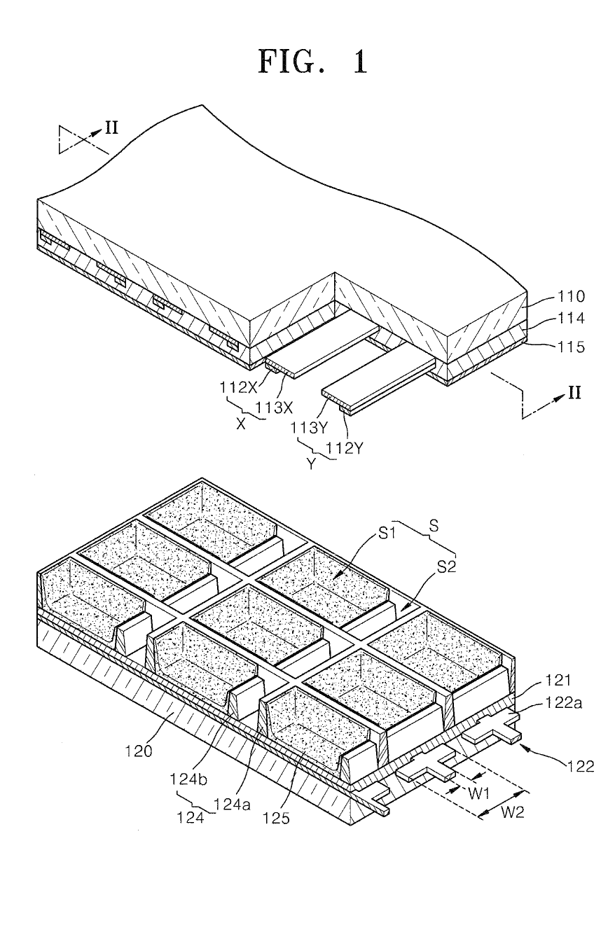

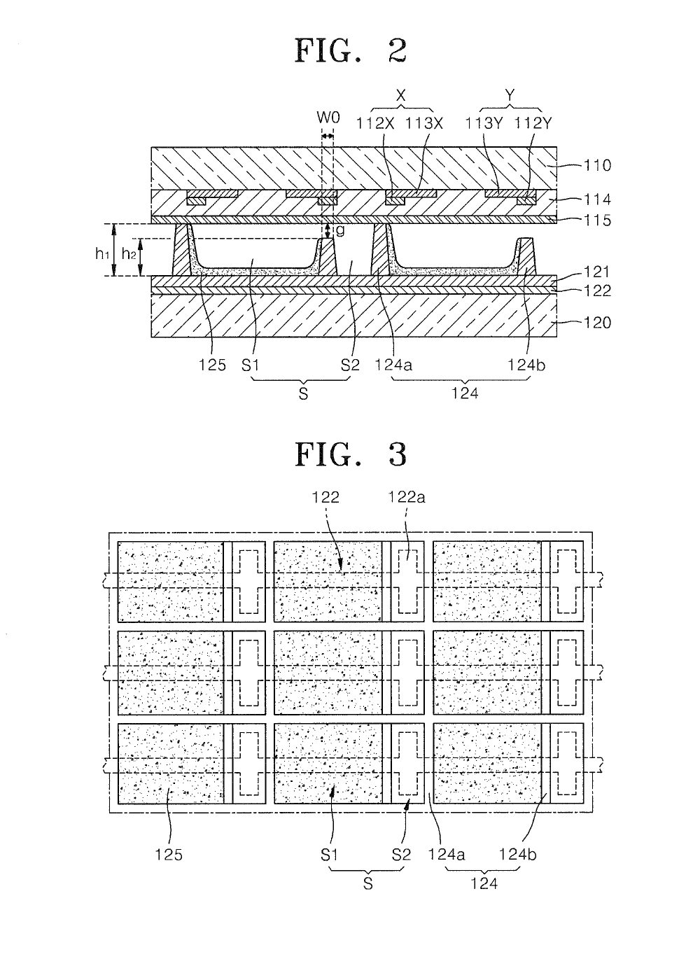

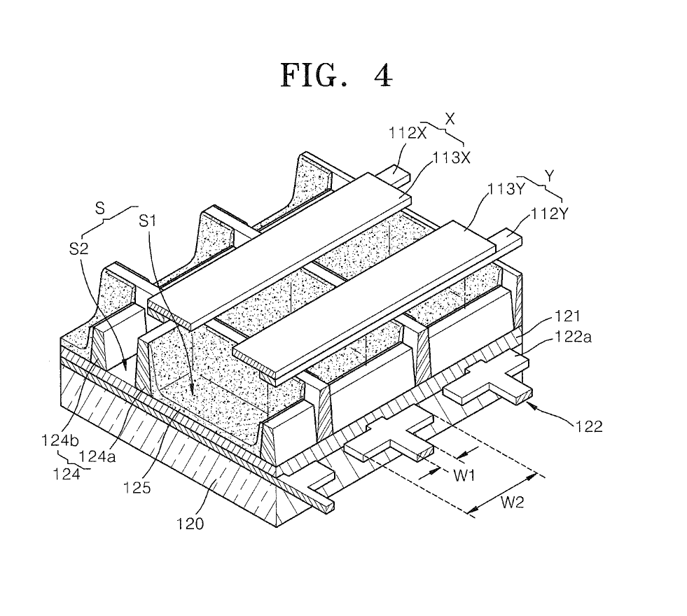

FIG. 1 is partial exploded perspective view of a PDP according to a first embodiment of the present invention, FIG. 2 is a vertical cross-sectional view of the PDP of FIG. 1 taken along the line II-II, FIG. 3 is a plan view of the PDP of FIG. 1, and FIG. 4 is a perspective view illustrating the arrangement of some of the components of the PDP illustrated in FIG. 1.

The PDP of FIG. 1 includes a front substrate 110, a rear substrate 120 which is separated from and faces the front substrate 110, and a plurality of barrier ribs 124 dividing a space between the front substrate 110 and the rear substrate 120 into a plurality of unit cells S.

A unit cell S among the plurality of unit cells S is a smallest light-emitting unit of the PDP in which a pair of sustain electrodes X and Y generate a display discharge and in which an address electrode 122 is extended to cross the pair of sustain electrodes X and Y, and the unit cell S is defined by the barrier ribs 124, thereby realizing a display (e.g., a predetermined display). Each unit cell S constitutes an independent light emitting area.

The pair of sustain electrodes X and Y includes a sustain electrode X and a scan electrode Y that perform display discharges between them. The sustain electrodes X and Y respectively include bus electrodes 112X and 112Y that form power supply lines, and transparent electrodes 113X and 113Y, which may be formed of an optically transparent material, that are electrically connected to the bus electrodes 112X and 112Y. The sustain electrodes X and Y extend in a direction (e.g., a width-wise direction) across the unit cells S.

The pair of sustain electrodes X and Y may be covered with a dielectric layer 114 so that the pair of sustain electrodes X and Y are not directly exposed to a discharge environment, and thus are protected from direct collisions with charged particles participating in a discharge. The dielectric layer 114 can be protected by a protective layer 115 formed of, for example, an MgO thin film. The protective layer 115 may induce emission of secondary electrons, thereby facilitating a discharge.

The address electrode 122 is disposed on the rear substrate 120. The address electrode 122 performs an address discharge together with the scan electrode Y. In each unit cell S, the address electrode 122 is disposed in such a manner that the address electrode 122 crosses (e.g., is perpendicular to) the scan electrode Y. The address discharge is a kind of auxiliary discharge that supports a display discharge by accumulating priming particles in each unit cell S before a display discharge occurs. A discharge voltage applied between the scan electrode Y and the address electrode 122 can be focused in an area that is in the vicinity of a discharge gap g (shown in FIG. 2) through the dielectric layer 114 that covers the scan electrode Y and the barrier ribs 124 on the address electrode 122. Therefore, an initial discharge may occur through the discharge gap g that provides a shortest discharge path.

For example, the address electrode 122 is covered with a dielectric layer 121 on the rear substrate 120, and the barrier ribs 124 are formed on the dielectric layer 121 that provides a plane surface to the barrier ribs 124. The barrier ribs 124 define, within each unit cell S, a primary discharge space S1 and an auxiliary discharge space S2 that is adjacent to the primary discharge space S1, between the front substrate 110 and the rear substrate 120. According to the first embodiment of the present invention, each of the barrier ribs 124 includes a first barrier rib 124a having a first height h1 that defines the unit cells S between the front substrate 110 and the rear substrate 120, and a second barrier rib 124b having a second height h2 that divides each unit cell S into a primary discharge space S1 and an auxiliary discharge space S2. Herein, such a division is made according to their discharge volumes for the sake of convenience, but functions of the primary discharge space S1 and the auxiliary discharge space S2 are not completely different from each other. For example, the display discharge can occur in the form of a long gap discharge in the auxiliary discharge space S2, in addition to in the primary discharge space S1.

The address electrode 122 according to the first embodiment of the present invention is formed to have a hammer-like shape so that a portion of the address electrode 122 corresponding to the auxiliary discharge space S2 has a wider width than a portion of the address electrode 122 corresponding to the primary discharge space S1. For a conventional PDP, a sustain discharge requires a higher voltage than that of an address discharge, and thus, the conventional PDP should be provided with a low input voltage, that is, a low address voltage, and a sufficient voltage margin are required. However, the conventional PDP's address electrode has a uniform width, and thus, it is difficult to decrease the address voltage. In order to overcome such a limitation, according to the first embodiment of the present invention, the address electrode 122 has a plurality of protrusions 122a for reducing the address voltage.

Referring to FIG. 3, each of the protrusions 122a has a width W2 (shown in FIG. 1) that is relatively wider than a width W1 (shown in FIG. 1) of the other portions of the address electrode 122. In this regard, the address discharge can easily occur in the auxiliary discharge space S2 when the auxiliary discharge space S2 is located on the protrusion 122a of the address electrode 122. That is, at least one portion of each protrusion 122a of the address electrode 122 is formed directly under at least one portion of the auxiliary discharge space S2 so that the protrusion 122a and the auxiliary discharge space S2 may overlap each other. According to the first embodiment, the protrusions 122a of the address electrode 122 have area sizes equal to or smaller than that of the auxiliary discharge space S2.

As such, a portion of the address electrode 122 corresponding to the auxiliary discharge space S2 has a larger width than a portion of the address electrode 122 corresponding to the primary discharge space S1. Therefore, an address voltage can be reduced, and thus, there is no need for a protective layer including, for example, an MgO thin film that induces emission of secondary electrons and activates a discharge. Thus, the manufacturing cost of a PDP can be reduced, and the manufacturing processes of a PDP can be simplified.

The first barrier rib 124a may have the first height h1 so that the unit cells S are substantially sealed from each other to prevent optical and electrical cross-talk between adjacent unit cells S. However, the term “seal” does not mean that the unit cells S are hermetically sealed, and a gap having a minute size under a tolerance limit may exist between the first barrier rib 124a and the dielectric layer 114 (or the protective layer 115).

The second barrier rib 124b may have the second height h2 that is less than the height of the first barrier rib 124a so that the discharge gap g may be formed having a width (e.g., a predetermined width). Therefore, the discharge gap g can provide a path for priming particles formed as a result of the address discharge and for priming particles formed in the auxiliary discharge space S2 to flow into the primary discharge space S1. Priming particles that are formed in the auxiliary discharge space S2 as a result of the address discharge are easily diffused to the primary discharge space S1 following the flow path provided by the discharge gap g on the second barrier rib 124b so as to participate in the display discharge.

The address voltage applied between the scan electrode Y and the address electrode 122 may generate more discharge activities in the auxiliary discharge space S2 than in the primary discharge space S1 that is coated by a phosphor layer 125. In this regard, the auxiliary discharge space S2 should have a sufficient volume such that a sufficient volume of discharge gas can be contained therein so as to supply sufficient priming particles generated by the address discharge. For example, in each unit cell S, the location of the second barrier rib 124b can be adjusted to increase or decrease the volume of the auxiliary discharge space S2.

The address discharge can occur at and in the vicinity of the discharge gap g, by using a top surface of the second barrier rib 124b facing the scan electrode Y as a facing discharge surface. In this regard, the scan electrode Y and the second barrier rib 124b may be aligned to reduce a distance of a discharge path. For example, the scan electrode Y and the second barrier rib 124b may partially overlap each other by a width WO.

The address discharge occurs usually in the auxiliary discharge space S2 and provides priming particles that participate in a display discharge. That is, the address discharge itself is not related to a display emission. When a discharge light is inevitably generated during the address discharge and leaks outside of the PDP together with a display emission, noise brightness that appears as a haze occurs adjacent to an emission pixel, and thus, the clarity of a display can be reduced. In order to prevent or reduce such problems, the discharge light generated in the auxiliary discharge space S2 can be blocked by forming black stripes on the auxiliary discharge space S2. However, according to the first embodiment, formation of such black stripes is not necessary since the bus electrode 112Y that constitutes a part of the scan electrode Y is, in general, formed of a metallic conductive material, and thus the bus electrode 112Y itself can block light.

In this regard, according to the first embodiment of the present invention, the primary discharge space S1 for a display discharge and an auxiliary discharge space S2 for an address discharge are separated from each other, and a technical method that can block the discharge light can be easily designed. For example, a black stripe can be selectively disposed over the auxiliary discharge space S2. However, in terms of conventional technology, a display discharge and an address discharge occur at the same place, and thus, a discharge light cannot be blocked or reduced, and display quality is decreased. Specifically, a visible light generated by phosphor activated by the address discharge forms a background light, and a contrast effect may be degraded. However, according to the first embodiment of the present invention, the phosphor layer 125 is structurally isolated from the auxiliary discharge space S2 in which the address discharge primarily occurs. Therefore, the background light generated when the phosphor layer 125 emits light during the address discharge can be completely removed or reduced, and a high-quality display having a high contrast effect can be realized.

The phosphor layer 125 is formed on inner walls of the primary discharge space S1. For example, the phosphor layer 125 can be formed on side walls of the first and second barrier ribs 124a and 124b that border the primary discharge space S1, and on a portion of the dielectric layer 121 between the first and second barrier ribs 124a and 124b. The phosphor layer 125 can react with ultraviolet light generated as a result of the display discharge to emit visible light of various colors. For example, one of red (R), green (G), and blue (B) phosphors that realize different colors from each other is coated on the inside of the primary discharge space S1, and thus, the primary discharge space S1 or the unit cell S is defined as an R sub pixel, a G sub pixel, or a B sub pixel.

The phosphor layer 125 may not be formed in the auxiliary discharge space S2. Different phosphors having different kinds of materials have different electrical properties and can affect a discharge environment to a large degree. For example, a zinc silicate-based G phosphor, such as Zn₂SiO₄:Mn tends to have a negative (−) surface potential; on the other hand, R and B phosphors, such as Y(V,P)O₄:Eu or BAM:Eu, tend to have positive (+) surface potential. Therefore, in order to obtain a uniform discharge by excluding the effects of the different phosphors on the discharge, phosphor should be isolated from the path of the address discharge. Thus, according to the first embodiment, the phosphor layer 125 is not coated in the auxiliary discharge space S2.

With regard to a conventional PDP, phosphor is directly exposed to an address discharge. In this case, even when the same address voltage is applied to all discharge spaces, voltages inside the discharge spaces may vary according to electrical properties of the phosphors in the discharge spaces. That is, a G phosphor that tends to be negatively (−) charged reduces the address voltage. On the other hand, R and B phosphors that tend to be positively (+) charged increases the address voltage. Therefore, although the same address voltage is applied to the G, R, and B phosphors, voltages in discharge spaces having the G, R, and B phosphors may differ from each other, and thus, an address voltage margin can be decreased.

When the primary discharge space S1 in which a display discharge primarily occurs is spatially separated from the auxiliary discharge space S2 in which an address discharge primarily occurs, and phosphor is selectively not formed in the auxiliary discharge space S2, an address voltage can be uniformly provided to all of the auxiliary discharge spaces S2 without any distortion (or substantially no distortion) caused by unique electrical properties of the phosphor, and thus, the address voltage margin can be significantly increased. In addition, compared to conventional techniques, the same pre-discharge effect can be obtained using only a lower address voltage, and when the same address voltage is applied, more priming particles can be accumulated, and the subsequent display discharge can have higher discharge intensity.

A discharge gas acting as a source gas for ultraviolet light is provided to the unit cells S each including the primary discharge space S1 and the auxiliary discharge space S2. The discharge gas can be a multiatomic gas including Xe, Kr, He, and Ne in a volume ratio (e.g., a predetermined volume ratio), which can emit ultraviolet rays through discharge excitation. It is well known that when the partial pressure of Xe in the multiatomic gas is high, that is, a high-Xe discharge gas is used, high emission efficiency can be obtained. However, the high-Xe discharge gas cannot be practically applied or has limited applications because it consumes a large amount of operation power due to high discharge initial voltage and a circuit that can cope with high power. However, a PDP according to the first embodiment of the present invention can provide a high address voltage, and sufficient priming particles can be obtained to activate a discharge. Therefore, a high-Xe PDP can be realized, and emission efficiency can be significantly improved.

### Second Embodiment

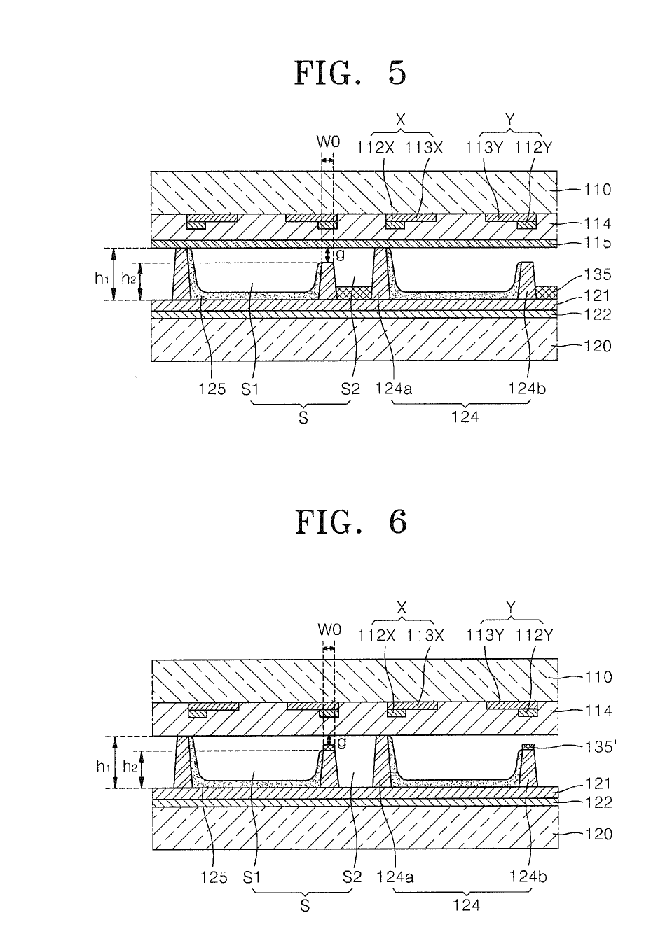

FIG. 5 is a vertical cross-sectional view of a PDP according to a second embodiment of the present invention. Referring to FIG. 5, a front substrate 110 faces a rear substrate 120, and first and second barrier ribs 124a and 124b define a primary discharge space S1 and an auxiliary discharge space S2 between the front substrate 110 and the rear substrate 120. A second barrier rib 124b of the second barrier ribs 124b is formed to have a second height h2 in such a manner that the second barrier rib 124b faces and is separated from a scan electrode Y by a distance of a discharge gap g.

The second embodiment is different from the first embodiment in that an electron emission material layer 135 is further formed in the auxiliary discharge space S2. The electron emission material layer 135 provides secondary electrons to the auxiliary discharge space S2 so as to activate a discharge in such a manner that an address discharge is focused in the auxiliary discharge space S2. The electron emission material layer 135 may contain any material that induces emission of electrons. For example, the electron emission material layer 135 can contain, but not limited to, MgO nano powder, a Sr—CaO layer, carbon powder, metal powder, MgO paste, ZnO, boron nitride (BN), metal-insulator-semiconductor (MIS) nano powder, oxidized porous silicon (OPS) nano powder, carbon driven carbon (CDC), carbon emitter layer (CEL), or the like. In addition to charged particles generated by ionization as a result of a discharge, secondary electrons can be provided to a discharge space by the electron emission material layer 135 according to a field emission principle. Therefore, a discharge can be easily initiated and activated.

### Third Embodiment

FIG. 6 is a vertical cross-sectional view of a PDP according to a third embodiment of the present invention. Referring to FIG. 6, a front substrate 110 faces a rear substrate 120, and first and second barrier ribs 124a and 124b define a primary discharge space S1 and an auxiliary discharge space S2 between the front substrate 110 and the rear substrate 120. The second barrier rib 124b is formed to have a second height h2 in such a manner that the second barrier rib 124b faces and is separated from a scan electrode Y by a distance of a discharge gap g.

The second embodiment is different from the previous embodiments in that an electron emission material layer 135′ is further formed on a top surface of the second barrier rib 124b that forms a discharge surface. The electron emission material layer 135′ contains a material that reacts with a discharge field focused in the vicinity of the discharge gap g so as to induce emission of electrons. For example, such a material can be, but not limited to, MgO nano powder, Sr—CaO layer, carbon powder, metal powder, MgO paste, ZnO, BN, MIS nano powder, OPS nano powder, CDC, CEL, or the like. In addition to charged particles generated by ionization as a result of a discharge, secondary electrons can be provided to a discharge space by the electron emission material layer 135′ according to a field emission principle. Therefore, a discharge can be easily initiated and activated.

### Fourth Embodiment

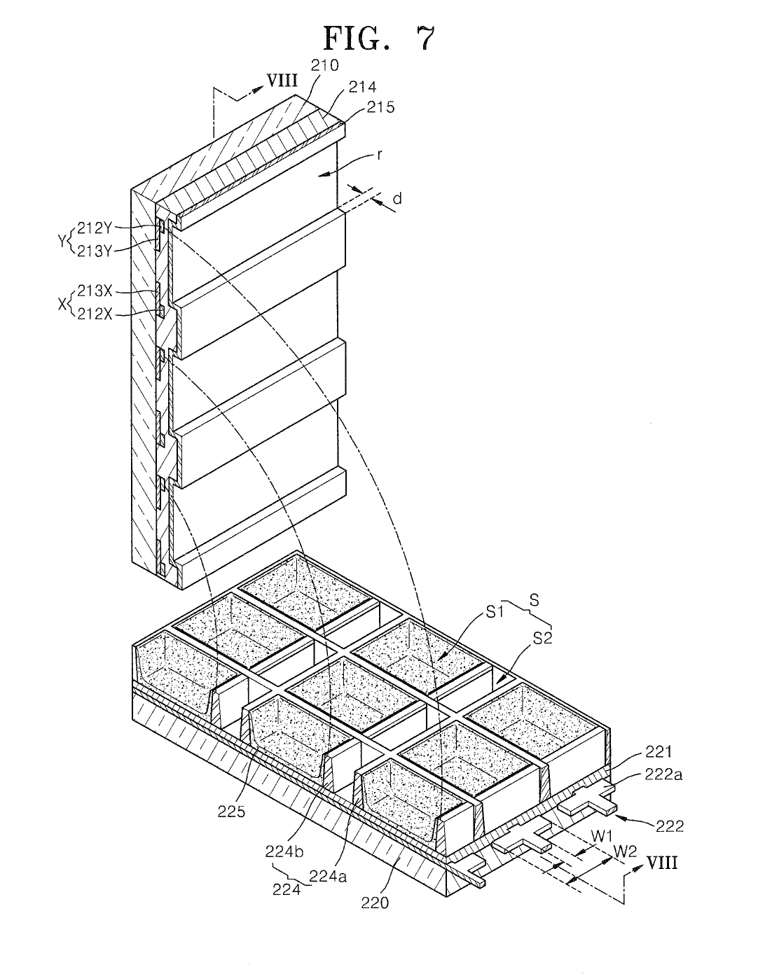

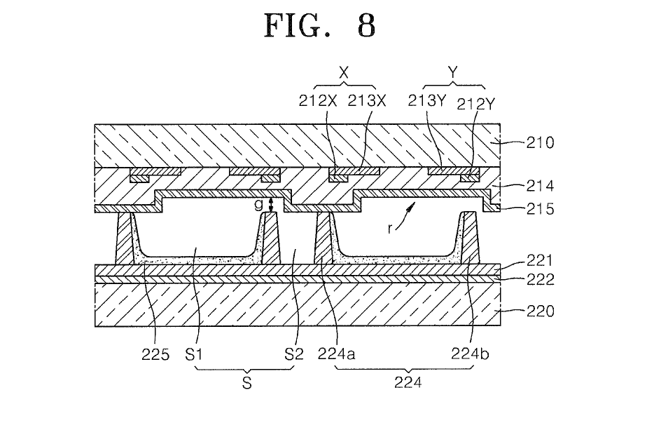

FIG. 7 is a partial exploded perspective view of a PDP according to a fourth embodiment of the present invention. FIG. 8 is a vertical cross-sectional view of the PDP of FIG. 7, taken along the line VIII-VIII.

Referring to FIGS. 7 and 8, a front substrate 210 faces a rear substrate 220, a plurality of first barrier ribs 224a define a plurality of unit cells S between the front substrate 210 and the rear substrate 220, and a second barrier rib 224b divides each of the unit cells S into a primary discharge space S1 and an auxiliary discharge space S2. Each of the unit cells S defined by the first barrier ribs 224a corresponds to a pair of a scan electrode Y and a sustain electrode X that perform a display discharge and an address electrode 222 that extends in a direction perpendicular to the direction in which the scan electrode Y extends and generates an address discharge together with the scan electrode Y. The sustain electrode X and the scan electrode Y can respectively include bus electrodes 212X and 212Y and transparent electrodes 213X and 213Y. The sustain electrode X and the scan electrode Y can be covered with a dielectric layer 214. In addition, a protective layer 215 can be further formed on the dielectric layer 214. The protective layer 215 can include, for example, an MgO layer, and induces emission of secondary electrons so as to activate a discharge.

A dielectric layer 221 can be formed on the address electrode 222 on the rear substrate 220. The second barrier rib 224b may correspond to the scan electrode Y. In some embodiments, the second barrier rib 224b faces the scan electrode Y, and the second barrier rib 224b is separated from the scan electrode Y by a distance of the discharge gap g. Therefore, the second barrier rib 224b can provide a facing discharge surface.

Herein, in the fourth embodiment, the address electrode 222 has a hammer-like shape in such a manner that a portion of the address electrode 222 corresponding to the auxiliary discharge space S2 is wider than a portion of the address electrode 222 corresponding to the primary discharge space S1. That is, the address electrode 222 includes a protrusion 222a for reducing an address voltage. In the fourth embodiment, in the address electrode 222, a width W2 of the protrusion 222a is relatively larger than a width W1 of the other portions thereof. In this regard, the auxiliary discharge space S2 can be formed on the protrusion 222a of the address electrode 222 so as to smoothly perform an address discharge in the auxiliary discharge space S2. That is, the protrusion 222a of the address electrode 222 can be formed directly under at least a portion of the auxiliary discharge space S2 in such a manner that the protrusion 222a and the auxiliary discharge space S2 may overlap each other. Herein, a section of the protrusion 222a may be equal to or smaller than that of the auxiliary discharge space S2. As such, a portion of an address electrode 222 corresponding to the auxiliary discharge space S2 is wider than a portion of the address electrode 222 corresponding to the primary discharge space S1, and thus, an address voltage can be decreased.

In the fourth embodiment, first and second barrier ribs 224a and 224b have substantially the same height h, and a dielectric layer 214 covering the scan electrode Y has a groove r having a depth d (e.g., a predetermined depth) to form the discharge gap g. The groove r is formed to correspond at least to the scan electrode Y, and, as illustrated in FIG. 7, extends toward the sustain electrode X. Priming particles accumulated in the auxiliary discharge space S2 due to an address discharge disperse to the primary discharge space S1 through the discharge gap g and participate in a display discharge.

Although not illustrated, an electron emission material layer can be further formed in the auxiliary discharge space S2. When the electron emission material layer is formed in the auxiliary discharge space S2, the electron emission material layer provides secondary electrons to the auxiliary discharge space S2 and activates a discharge. Therefore, an address discharge can be focused in the auxiliary discharge space S2. The electron emission material layer can contain any suitable material that has an electron emission characteristic (e.g., a predetermined electron emission characteristic), such as, but not limited to, MgO nano powder, Sr—CaO layer, carbon powder, metal powder, MgO paste, ZnO, BN, MIS nano powder, OPS nano powder, CDC, or CEL.

Although not illustrated, an electron emission material layer can be formed on the second barrier rib 224b. When the electron emission material layer is formed on the second barrier rib 224b, an address discharge can be easily initiated and activated. The electron emission material layer reacts with a high electric field focused in the vicinity of the discharge gap g and emits secondary electrons. The electron emission material layer can contain any material that has an electron emission characteristic (e.g., a predetermined electron emission characteristic), such as, but not limited to, MgO nano powder, Sr—CaO layer, carbon powder, metal powder, MgO paste, ZnO, BN, MIS nano powder, OPS nano powder, CDC, CEL, or the like.

In a PDP according to the embodiments of the present invention, a portion of an address electrode corresponding to an auxiliary discharge space in which an address discharge occurs is wider than another portion of the address electrode so as to reduce an address voltage. In addition, effects on discharge from phosphor disposed in the path of an address discharge can be prevented, and an address voltage margin can be increased. Therefore, a highly efficient display can be realized using a high Xe discharge gas. Thus, the amount of power consumed in a full-HD display having a high resolution can be reduced.

Furthermore, according to the embodiments of the present invention, a noise brightness that appears as a haze in the vicinity of a display emission and degrades a degree of clarity of an image, such as a discharge light generated when an address discharge occurs or a background light, can be removed, and thus a high quality image having a high contrast effect can be obtained.

While the present invention has been particularly shown and described with reference to exemplary embodiments thereof, it will be understood by those of ordinary skill in the art that various changes in form and details may be made therein without departing from the spirit and scope of the present invention as defined by the following claims, and their equivalents.

What is claimed is:

1. A plasma display panel (PDP) comprising:
a first substrate and a second substrate facing each other;
a plurality of first barrier ribs defining a plurality of cells between the first substrate and the second substrate;
pairs of scan electrodes and sustain electrodes extending on the first substrate and configured to generate display discharges in the plurality of cells;
a plurality of second barrier ribs on the second substrate each dividing a corresponding one of the cells into a primary discharge space and an auxiliary discharge space adjacent to the primary discharge space, a second barrier rib among the second barrier ribs being closer to a corresponding scan electrode among the scan electrodes than a corresponding sustain electrode among the sustain electrodes;
a plurality of address electrodes configured to perform address discharges together with the scan electrodes, the plurality of address electrodes extending on the second substrate in a direction perpendicular to a direction in which the scan electrodes extend, wherein a portion of an address electrode among the address electrodes is wider than another portion of the address electrode; and
a phosphor layer formed in the primary discharge space.

2. The PDP of claim 1, wherein the portion of the address electrode corresponds to the auxiliary discharge space and is wider than a portion of said another portion of the address electrode corresponding to the primary discharge space.

3. The PDP of claim 1, wherein each of the address electrodes comprises one or more protrusions.

4. The PDP of claim 3, wherein at least one portion of the one or more protrusions is directly under at least one portion of the auxiliary discharge space, and the at least one portion of the one or more protrusions and the at least one portion of the auxiliary discharge space overlap each other.

5. The PDP of claim 1, wherein the second barrier ribs face the scan electrodes, and a plurality of discharge gaps are between the second barrier ribs and the scan electrodes.

6. The PDP of claim 1, wherein the second barrier ribs have a height less than that of the first barrier ribs.

7. The PDP of claim 1, wherein the phosphor layer is not formed in the auxiliary discharge space.

8. The PDP of claim 1, further comprising a protective layer on the scan electrodes and the sustain electrodes.

9. The PDP of claim 1, further comprising an electron emission material layer in the auxiliary discharge space.

10. The PDP of claim 1, further comprising an electron emission material layer on top surfaces of the second barrier ribs adjacent to the scan electrodes.

11. A plasma display panel (PDP) comprising:
a first substrate and a second substrate facing each other;
a plurality of first barrier ribs on the second substrate defining a plurality of cells between the first substrate and the second substrate;
pairs of scan electrodes and sustain electrodes extending on the first substrate and configured to generate discharges in the plurality of cells;
a dielectric layer on the scan electrodes and the sustain electrodes and having grooves in positions at least corresponding to the scan electrodes;
a plurality of second barrier ribs each dividing a corresponding one of the cells into a primary discharge space and an auxiliary discharge space adjacent to the primary discharge space, a second barrier rib among the second barrier ribs being closer to a corresponding scan electrode among the scan electrodes than a corresponding sustain electrode among the sustain electrodes;
a plurality of address electrodes configured to perform address discharges together with the scan electrodes, and the plurality of address electrodes extending on the second substrate in a direction perpendicular to a direction in which the scan electrodes extend, wherein a portion of an address electrode among the address electrodes is wider than another portion of the address electrode; and
a phosphor layer in the primary discharge space.

12. The PDP of claim 11, wherein the portion of the address electrode corresponds to the auxiliary discharge space and is wider than a portion of said another portion of the address electrode corresponding to the primary discharge space.

13. The PDP of claim 11, wherein each of the address electrodes comprises one or more protrusions.

14. The PDP of claim 13, wherein at least one portion of the one or more protrusions is directly under at least one portion of the auxiliary discharge space, and the at least one portion of the one or more protrusions and the at least one portion of the auxiliary discharge space overlap each other.

15. The PDP of claim 11, wherein the second barrier ribs face the scan electrodes, and discharge gaps are between the second barrier ribs and the scan electrodes.

16. The PDP of claim 11, wherein the first and second barrier ribs have a same height.

17. The PDP of claim 11, wherein the phosphor layer is not formed in the auxiliary discharge space.

18. The PDP of claim 11, further comprising a protective layer covering the pairs of the scan electrodes and the sustain electrodes.

19. The PDP of claim 11, further comprising an electron emission material layer in the auxiliary discharge space.

20. The PDP of claim 11, further comprising an electron emission material layer on top surfaces of the second barrier ribs adjacent to the scan electrodes.
